(19) United States
(12) Patent Application Publication
(10) Pub. No.: US 2014/0370382 A1
(43) Pub. Date: Dec. 18, 2014

(54) HYBRID BATTERY BINDER

(71) Applicant: E I DU PONT DE NEMOURS AND COMPANY, Wilmington, DE (US)

(72) Inventor: CHONGSOO LIM, HOCKESSIN, DE (US)

(21) Appl. No.: 14/301,631

(22) Filed: Jun. 11, 2014

Related U.S. Application Data
(60) Provisional application No. 61/834,026, filed on Jun. 12, 2013.

(51) Int. Cl. H01M 4/62; H01M 4/525; H01M 4/505

(52) U.S. Cl. CPC H01M 4/622; H01M 4/625; H01M 4/505; H01M 4/525
USPC 429/217; 252/506; 524/104

(57) ABSTRACT

Disclosed is a composition comprising an ethylene copolymer and a polyetherimide, polyamideimide, polycarbonate, polyetheretherketone, polysulfone or polyethersulfone wherein the ethylene copolymer comprises or is produced from repeat units derived from ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; and the composition can further comprise a curing agent to crosslink the ethylene copolymer. The composition is useful as a binder for a lithium ion battery.

### CROSS REFERENCE TO RELATED APPLICATION

This application claims priority from U.S. provisional application Ser. No. 61/834,026, filed Jun. 12, 2013; incorporated by reference herein in its entirety.

### FIELD OF THE INVENTION

The invention relates to a binder composition and its use in a secondary battery, such as lithium ion battery.

### BACKGROUND OF THE INVENTION

Since commercial lithium ion batteries were first developed by Sony in the early 1990s, they have been widely adopted in portable electronics such as laptops, tablets and smartphones due to their high energy density, high working voltages, and excellent flexibilities in shapes and sizes. These properties allow lithium ion batteries to accommodate demanding needs from rapidly evolving electronic devices more readily than conventional secondary batteries. Lithium ion batteries are considered as desirable alternative energy sources in emerging markets such as electrified vehicles and energy storage, which will bring about new opportunities and challenges simultaneously.

A lithium ion battery (LIB) typically comprises four components including a negative electrode (anode), a positive electrode (cathode), an electrolyte and a separator, which work in harmony to interconvert chemical energy into electrical energy reversibly as current flow reverses during charge and discharge processes. Typically electrodes are constructed by applying active material onto a current collector in the presence of a binder that affords cohesion between active materials and their adhesion to the current collector. The binder is commonly combined with carbon black for electrical conductivity. Common active materials for anodes include carbon (graphite) or silicon, and, for cathodes, lithium metal oxides, mixed metal oxides, or metal salts of usually lithium. The current collector for anodes is typically Cu, and for cathodes Al. The electrolyte can be a mixture of organic carbonates containing lithium salts. The organic carbonates can include ethylene carbonate, ethyl methyl carbonate, diethyl carbonate, or combinations thereof. The lithium salts can include LiPF₆, LiBF₄, LiAsF₆, LiClO₄, LiCF₃SO₃, LiN(SO₂CF₃)₂ or combinations thereof. The separator is commonly made from a stretched and thus micro-porous multilayered film of polyethylene, polypropylene or combinations thereof.

Widely used binders comprise homopolymers and copolymers of polyvinylidene fluoride (PVDF), which have gained success as binders for cathodes and anodes in lithium ion battery technology. PVDF and copolymers such as a copolymer of vinylidene fluoride and hexafluoropropylene (p(VDF-HFP)) are also used as polymer electrolytes and separators alone or in combination with other materials. PVDF might have suitable properties for lithium ion battery application such as relatively wide redox window for electrochemical stability, high molecular weight for strong adhesion to current collector and robust cohesion between active materials, high polarity to increase compatibility with polar cathode active material, proper viscosity, and commercial availability in high purity. However, it is sometimes reported that PVDF needs improvement in adhesion, percent active loading, swelling behavior and flexibility. As portable electronics become slimmer and flexible in some cases like wearable electronics, the semicrystallinity of PVDF may become a significant drawback. Additionally, the oxidative stability of PVDF is arguably considered not strong enough to accommodate higher operating voltage needs. Another problem of PVDF is a limited aqueous binder system despite the fact that most of them are synthesized by some aqueous processes. The PVDF polymer in aqueous dispersions or emulsions is in the form of tiny semicrystalline solid particles, which is a significantly different morphology than in N-methyl-2-pyrrolidone (NMP) solution. In order to work as a binder, polymeric chains in PVDF need to be disentangled from each other and appropriately interact with other components in electrode slurry materials. Due to PVDF's high melting point (around 170° C.) aqueous PVDF binders may not go through film forming process effectively in the existing LIB process. Also, additives for the emulsions or dispersions such as surfactants and rheology modifiers can interfere with lithium ion battery action. Although NMP is used as a typical solvent for PVDF, it might need to be deselected at a certain point due to its toxicity. These drawbacks of PVDF can be magnified depending on specific applications.

Polyolefinic materials with electron withdrawing substituents such as poly(methyl methacrylate) (PMMA), polyacrylic acids, polyacrylonitrile (PAN) and polyvinyl chloride (PVC) have also been adopted in lithium ion battery technology. Japanese patent application JP2012-109143 discloses electrochemical cells including a binder comprising a fluororesin aqueous dispersion and water-soluble polyamideimide resin.

WO2013/008564 discloses a polymeric blend for cathode binder that has multimodal particle size distribution measured by dynamic light scattering. At least one of the polymeric particles contains fluoropolymers such as PVDF, p(HFP-VDF), PTFE or combinations of fluoropolymers blended with polyacrylic acids. The cathode made therefrom was reported to show high ion conductivity, good oxidation stability, good cohesion between active material and good adhesion to the current collector.

JP2012-238488 describes a polymeric blend of acrylic polymer and polyvinyl acetate having an excellent resistance toward electrolytic solution.

JP2012-234707 discloses polymeric mixtures of acid-modified polyolefins and dimer acid-based polyamides that show excellent adhesiveness and flexibility.

A blended binder of polyimide-poly(vinylidene fluoride) adapted for a Si anode was described in Japanese patent application JP2012-209219.

US Patent Application Publication US2012/0311870 discloses electrochemical cells comprising a binder that is an unsaturated carboxylic acid ester copolymer having a content of alkyl acrylate monomer units of 85 mass % or higher.

WO2012082991 and U.S. Pat. No. 6,723,785 disclose a process for making an aqueous dispersion of nonaqueous soluble material by using an organic solvent and a water-soluble polymer as a dispersant during the milling process.

It is desirable to develop additional binder materials in order to provide improved lithium batteries especially for use in the cathode.

### SUMMARY OF THE INVENTION

This invention provides a blend composition comprising
(a) an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer; and
(b) a polymeric material selected from the group consisting of polyetherimide (PEI), polyamideimide (PAI), polycarbonate (PC), polyetheretherketone (PEEK), polysulfone (PS) and polyethersulfone (PES).

The blend composition may further comprise a metal oxide, mixed metal oxide, metal phosphate, metal salt, or combinations of two or more thereof, and optionally an electrical conductivity aid.

The invention also provides a method for preparing the blend composition above comprising
(1) preparing a mixture comprising an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer and an organic solvent;
(2) preparing a mixture comprising a polymeric material selected from the group consisting of polyetherimide, polyamideimide, polycarbonate, polyetheretherketone, polysulfone and polyethersulfone and an organic solvent;
(3) combining the mixture comprising the ethylene copolymer of (1) and the mixture comprising the polymeric material of (2).

The method may further comprise mixing the blend composition with a metal oxide, mixed metal oxide, metal phosphate, metal salt, or combinations of two or more thereof, and optionally an electrical conductivity aid.

The composition is useful as a binder composition for use in electrochemical cells such as lithium ion batteries. Accordingly, the invention also provides an electrochemical cell comprising the composition. The electrochemical cell may also comprise a negative electrode (anode), a positive electrode (cathode), an electrolyte and a separator.

### DETAILED DESCRIPTION OF THE INVENTION

All publications, patent applications, patents, and other references mentioned herein are incorporated by reference in their entirety.

Although methods and materials similar or equivalent to those described herein can be used in the practice or testing of the present invention, suitable methods and materials are described herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”. For example, a blend described as consisting essentially of two or more recited polymers does not contain any additional nonrecited polymers, but may contain other nonrecited nonpolymeric components.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers and/or to the amounts of its constituent comonomers such as, for example “a copolymer comprising ethylene and 15 weight % of methyl acrylate”. A description of a copolymer with reference to its constituent comonomers or to the amounts of its constituent comonomers means that the copolymer contains copolymerized units (in the specified amounts when specified) of the specified comonomers.

Functionalized ethylene copolymers have performance qualities that may allow them to be used as a binder material for lithium ion batteries such as robust adhesion to the current collector, stronger binding, suitable swelling in electrolytes, higher active material loading, excellent flexibility and a comparable operating (redox/thermal) window. Ethylene copolymers can be melt or solution blended with high performance engineering polymers such as polyetherimide (PEI), polyamideimide (PAI), polycarbonate (PC), polyetheretherketone (PEEK), polysulfone (PS) and/or polyethersulfone (PES). The hybrid of the ethylene copolymer and engineering plastics is a mixed binder system that might have comparable or even higher oxidative stability than PVDF. Here, the term “hybrid” means either an interpenetrating network (IPN) or polymeric blend made of two or more kinds of polymeric resins and compositions thereof. In an IPN, at least one polymeric component is chemically connected either from its monomer or oligomers to build its polymeric network through other polymeric component. Generally speaking, the IPN will form somewhat better mixed polymeric mixtures compared to conventional polymeric blends.

The hybrid binder approach can compensate for drawbacks of the individual components. The ethylene copolymers that form hybrids with engineering polymers are completely soluble in the typical electrolyte solvent such as Novolyte® 1M LiPF₆ 70-30 EMC-EC simply standing for overnight. Surprisingly, they withstand dissolution in the electrolytes after they form hybrids with the engineering polymers. This remarkable behavior still holds even without any dependence on the presence of curing agent or crosslinking in the hybrid system. Adding ethylene copolymers may improve the flexibility and adhesion to the electrode of the hybrid binder compared to binders comprising the engineering polymers alone.

Hybrids of ethylene copolymers with engineering polymers may be prepared by solution and/or extrusion blending, which may be soluble or dispersible in NMP. These physically blended hybrids also can be readily applicable in the existing processes. They can potentially improve oxidative stability over that of PVDF. Advantageously, the ethylene copolymer may be selected to maintain excellent chain mobility at the normal drying temperature of LIB processes, which will provide a somewhat better environment for high melting performance polymers such as PEI, PAI, PC, PEEK, PS or/and PES to extend their polymer chains inside the electrode coating to form a solid binder network.

These hybrid binder resins also can be dispersed in aqueous media by methods widely used in related arts. First, the binder or its blended mixture may be dissolved in suitable solvent or mixed solvents. Then, organic solutions of the binders can be dispersed in aqueous media in the presence of surfactants, especially polymeric surfactants.

The ethylene copolymer component of the binder compositions can be a dipolymer, a terpolymer, a tetrapolymer, or combinations thereof. The ethylene copolymer may be a copolymer comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof. In particular, it may be a copolymer having copolymerized units of ethylene and a comonomer selected from vinyl esters and α,β-unsaturated monocarboxylic acid esters wherein the polymer contains copolymerized units of at least 2 weight % of the comonomer. Preferably at least one comonomer in the copolymer is vinyl acetate, an alkyl acrylate and/or an alkyl methacrylate.

When the ethylene copolymer is an ethylene vinyl acetate copolymer, the percentage of copolymerized vinyl acetate units can vary broadly from 2 percent to as much as 40 weight % percent of the total weight of the copolymer or even higher.

The weight percentage of copolymerized vinyl acetate units in the copolymer will preferably be from 2 to 40 weight %, especially from 10 to 40 weight %. The ethylene/vinyl acetate copolymer preferably has a melt flow rate, measured in accordance with ASTM D-1238 at 190° C. with 2.16 kg mass, of from about 0.1 to about 40 g/10 minutes, and preferably from about 0.3 to about 30 g/10 minutes. The ethylene-containing copolymers useful in the compositions described herein can be modified by methods well known in the art, including chemical reaction by grafting with an unsaturated carboxylic acid or its derivatives, such as maleic anhydride or maleic acid.

A mixture of two or more different ethylene/vinyl acetate copolymers can be used in place of a single copolymer as long as the average values for the weight percentage of vinyl acetate comonomer units, based on the total weight of the copolymers, is within the range indicated above. Particularly useful properties may be obtained when two or more properly selected ethylene/vinyl acetate copolymers are used in the binder compositions.

The ethylene copolymer component may also be an ethylene/alkyl (meth)acrylate copolymer. The term “alkyl (meth)acrylate” means alkyl acrylate or alkyl methacrylate or a combination thereof and “ethylene/alkyl (meth)acrylate copolymer” means a thermoplastic copolymer derived from the copolymerization of ethylene and at least one alkyl acrylate or alkyl methacrylate comonomer or a combination thereof, wherein the alkyl group contains from 1 to 8 carbon atoms. Examples of alkyl acrylates suitable for use include, without limitation, methyl acrylate, ethyl acrylate and butyl acrylate and examples of alkyl methacrylates include methyl methacrylate, ethyl methacrylate and butyl methacrylate.

The relative amount of the alkyl (meth)acrylate comonomer incorporated as copolymerized units into the ethylene/alkyl (meth)acrylate copolymer can vary broadly from a few weight percent to as much as 45 weight %, based on the weight of the copolymer or even higher. For example, the alkyl group in the alkyl (meth)acrylate comonomer used to prepare the ethylene copolymer can be from one to 4 carbon atoms. Notably, the level of copolymerized units of alkyl (meth)acrylate comonomer in the ethylene/alkyl (meth)acrylate copolymer is within the range from 5 to 45 weight percent, preferably from 5 to 35 weight %, from 5 to 30, still more preferably from 9 to 28 weight % or 10 to 27 weight % of the total ethylene/(meth)acrylate copolymer, based on the weight of the copolymer. Methyl acrylate (the most polar alkyl acrylate comonomer) can be used to prepare an ethylene/methyl acrylate dipolymer. The methyl acrylate comonomer can be present in a concentration range of from 5 to 30, 9 to 25, or 9 to 24 weight %, of the ethylene copolymer.

The ethylene/(meth)acrylate copolymer preferably has a melt flow rate, measured in accordance with ASTM D-1238 at 190° C. with 2.16 kg. mass, from 0.1 to 40 g/10 minutes, and preferably from 0.3 to 30 g/10 minutes.

Mixtures of ethylene/alkyl (meth)acrylate copolymers may also be used, so long as the level of copolymerized units of (meth)acrylate is within the above-described range, based on the total weight of copolymer present.

A mixture of two or more ethylene copolymers can be used as component (a) in the compositions in place of a single copolymer. Particularly useful properties may be obtained when two properly selected ethylene/alkyl acrylate copolymers are used in blends. For example but not limitation, compositions include those wherein the ethylene/alkyl acrylate component comprises two different ethylene/methyl acrylate copolymers. Also for example, one may replace a single EMA grade in a blend with an equal amount of a properly selected mixture of two EMA grades, where the mixture has the same weight percent methyl acrylate content and melt index as the single EMA grade replaced. By combining two different properly selected EMA copolymer grades, modification of the properties of the composition may be achieved as compared with compositions containing only a single EMA resin grade.

Ethylene copolymers suitable for use herein can be produced by any process, including processes that involve use of a tubular reactor or an autoclave. Copolymerization processes conducted in an autoclave may be continuous or batch processes. In one such process, disclosed in general in U.S. Pat. No. 5,028,674, ethylene, the alkyl acrylate, and optionally a solvent such as methanol and/or a telogen such as propane to control the molecular weight, are fed continuously into a stirred autoclave such as the type disclosed in U.S. Pat. No. 2,897,183, together with an initiator. Ethylene/alkyl acrylate copolymers produced using an autoclave process can be obtained commercially, for example from Exxon/Mobil Corp, and/or from Elf AtoChem North America, Inc.

As generally recognized in the art, a tubular reactor copolymerization technique will produce a copolymer having a greater relative degree of heterogeneity along the polymer backbone (a more blocky distribution of comonomers), will tend to reduce the presence of long chain branching and will produce a copolymer characterized by a higher melting point than one produced at the same comonomer ratio in a high pressure stirred autoclave reactor. Tubular reactor produced ethylene/(meth)acrylate copolymers of this nature are commercially available from E.I. du Pont de Nemours and Company (DuPont), Wilmington, Del. under the Elvaloy® AC tradename.

The ethylene copolymer may also include at least one comonomer such as epoxide-containing monomer or an α,β-unsaturated dicarboxylic acid or its derivative. An epoxide-containing monomer can include glycidyl methacrylate, glycidyl acrylate, or combinations thereof. An example is an ethylene glycidyl methacrylate copolymer. An α,β-unsaturated dicarboxylic acid or its derivative can include maleic acid, fumaric acid, itaconic acid, a C₁-C₄ alkyl monoester of maleic acid, a C₁-C₄ alkyl monoester of fumaric acid, a C₁-C₄ alkyl monoester of itaconic acid, acid anhydride, or combinations of two or more thereof. An example is a copolymer comprising copolymerized units of ethylene and monoethyl maleic acid ester.

Terpolymers or higher order polymers may also be used. For example, ethylene, vinyl ester or an α,β-unsaturated ester and maleic anhydride, glycidyl methacrylate or carbon monoxide can be copolymerized to form terpolymers such as ethylene/methyl acrylate/maleic anhydride, ethylene/butyl acrylate/glycidyl methacrylate (EBAGMA), ethylene/butyl acrylate/carbon monoxide (EBACO) or ethylene/vinyl acetate/carbon monoxide (EVACO).

Notably, the ethylene copolymer is an ethylene methyl acrylate dipolymer, ethylene ethyl acrylate dipolymer, ethylene butyl acrylate dipolymer, ethylene methyl acrylate glycidyl methacrylate terpolymer, ethylene butyl acrylate glycidyl methacrylate terpolymer, or combinations of two or more thereof.

Ethylene copolymers with higher alkyl acrylate content, for example, greater than 45 weight % are elastomeric. Thus, elastomeric copolymers include a copolymer derived from copolymerization of

(a) from 13 to 50 weight % of ethylene;

(b) from 50 to 80 weight % of an alkyl acrylate; and

(c) from 0 to 7 weight % of a monoalkyl ester of 1,4-butene-dioic acid, wherein all weight percentages are based on total weight of components (a) through (c) in the copolymer.

The copolymer may contain monoalkyl esters of 1,4-butene-dioic acid moieties that function as cure sites at a loading from about 0.5 to 7 weight percent of the total copolymer (more preferably from 1 to 6 weight % and still more preferably from 2 to 5 weight %).

Thus, a preferred copolymer is derived from copolymerization of from 15 to 50 weight % of ethylene; from 50 to 80 weight % of an alkyl acrylate; and from 2 to 5 weight % of a monoalkyl ester of 1,4-butene-dioic acid.

Preferably the alkyl acrylate has from 1 to 8 carbon atoms in the alkyl group, preferably from 1 to 4 carbon atoms. Alternatively a mixture of alkyl acrylates may be used. For example, a first alkyl acrylate may be either methyl acrylate or ethyl acrylate and the second (and different) alkyl acrylate has from 4 to 8 carbon atoms, such as butyl acrylate. Preferably the total acrylate content comprises from about 50 to 75 weight percent of the copolymer, more preferably from 50 to 70 weight %.

The elastomeric copolymers may have number average molecular weight from about 40,000 to about 65,000 and melt indices from about 1 to about 6 g/10 minutes.

As indicated above, the composition includes random copolymers comprising ethylene and at least one alkyl acrylate, with or without an acid cure site. The alkyl acrylates have up to 8 carbon atoms in the pendent alkyl chains, which can be branched or unbranched. For example, the alkyl groups may be selected from methyl, ethyl, n-butyl, iso-butyl, hexyl, 2-ethylhexyl, n-octyl, iso-octyl, and other alkyl groups. Thus, the alkyl acrylates used in the preparation of the copolymers may be selected from methyl acrylate, ethyl acrylate, n-butyl acrylate, iso-butyl acrylate, hexyl acrylate, 2-ethylhexyl acrylate, n-octyl acrylate, iso-octyl acrylate, and other alkyl acrylates containing up to 8 carbon atoms in the alkyl groups. Preferably, when two or more alkyl acrylates are used, methyl acrylate or ethyl acrylate is used as the first alkyl acrylate and the second alkyl acrylate has from 2 to 8, more preferably 4 to 8, carbon atoms in the alkyl group (when ethyl acrylate is used as the first alkyl acrylate, the second alkyl acrylate has from 3 to 8, more preferably from 4 to 8, carbon atoms in the alkyl group). Notable combinations of alkyl acrylates include combinations of methyl acrylate and a second alkyl acrylate selected from the group consisting of ethyl acrylate, n-butyl acrylate, iso-butyl acrylate, 2-ethylhexyl acrylate, and n-octyl acrylate. Methyl acrylate with n-butyl acrylate and methyl acrylate with 2-ethylhexyl acrylate are preferred combinations.

Small amounts of other comonomers as generally known in the art can be incorporated into the copolymer. Thus for example, it is contemplated that small amounts (a few percent) of alkyl methacrylate comonomer can be used in addition to the alkyl acrylate. Alternatively, an alkyl methacrylate can be used to substitute for the second alkyl acrylate.

The copolymer may contain no cure site component, or higher copolymers may contain 1,4-butene-dioic acid moieties and anhydrides and monoalkyl esters thereof that function as acid cure sites. Of note are acid cure sites that comprise from about 0.5 to about 7 weight %, preferably from 1 to 6 weight %, more preferably from 2 to 5 weight %, of a monoalkyl ester of 1,4-butene-dioic acid, in which the alkyl group of the ester has from 1 to 6 carbon atoms, in the final copolymer. The 1,4-butene-dioic acid and esters thereof exist in either cis or trans form prior to polymerization, i.e. maleic or fumeric acid. Monoalkyl esters of either are satisfactory. Methyl hydrogen maleate, ethyl hydrogen maleate (EHM), and propyl hydrogen maleate are particularly satisfactory; most preferably EHM is to be employed.

As such, ethylene represents essentially the remainder of the copolymer relative to the required alkyl acrylates and the optional monoalkyl ester of 1,4-butene-dioic acid; i.e., polymerized ethylene is present in the copolymers in a complementary amount.

Examples of copolymers include copolymers of ethylene (E) and methyl acrylate (MA), and copolymers of ethylene (E), methyl acrylate (MA) and ethyl hydrogen maleate (EHM) (E/MA/nBA/EHM).

Copolymers with or without acid cure sites can be readily prepared by copolymerizing ethylene and alkyl acrylate(s) in the presence of a free-radical polymerization initiator including for example peroxygen compounds or azo compounds.

Elastomeric ethylene alkyl acrylate copolymers of this type are commercially available under the Vamac® tradename from DuPont.

The second component of the binder composition may be a polar polymer selected from the group consisting of polyetherimide (PEI), polyamideimide (PAI), polycarbonate (PC), polyetheretherketone (PEEK), polysulfone (PS) and polyethersulfone (PES), notably a polyetherimide.

Most polyimides have high thermal/oxidative stability but most of them are not soluble in organic solvents. Polyetherimides are commercially available from Sabic under the tradename Ultem®. Ultem® 1000 polyetherimide, with repeat element shown below, is transparent and amorphous due to its molecular structure. It is also soluble in NMP.

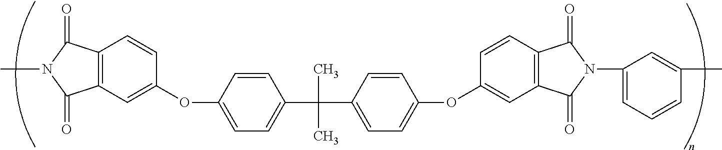

Polyamideimides are thermoplastic amorphous polymers that have exceptional mechanical, thermal and chemical resistant properties. They are generally prepared from reaction of a diisocyanate, often 4,4′-methylenediphenyldiisocyanate (MDI), with trimellitic anhydride (TMA). Polyamideimides are produced by Solvay Advanced Polymers under the trademark Torion®.

Polycarbonates contain carbonate groups (—O—(C═O)—O—). Most polycarbonates of commercial interest are derived from rigid monomers such as bisphenol A (BPA). Generally, polycarbonate material is produced by the reaction of BPA or other diols and phosgene or by transesterification with diphenyl carbonate. Other diols used in polycarbonates include 1,1-bis(4-hydroxyphenyl)cyclohexane and dihydrobenzophenone. The cyclohexane is used as a comonomer to suppress crystallization tendency of the BPA-derived product. Tetrabromobisphenol A is used to enhance fire resistance. Tetramethylcyclobutanediol has been developed as a replacement for BPA. Polycarbonates are commercially available from Sabic under the tradename Lexan®, among others.

Polyetherether ketone (PEEK) is a thermoplastic polymer in the polyaryletherketone (PAEK) family. PEEK polymers are obtained by step-growth polymerization by the dialkylation of bisphenolate salts. A typical process is the reaction of 4,4′-difluorobenzophenone with the disodium salt of hydroquinone, which is generated in situ by deprotonation with sodium carbonate. The reaction is conducted around 300° C. in polar aprotic solvents such as diphenyl sulfone. PEEK polymers are commercially available from Aetna Plastics, Cleveland, Ohio.

Polysulfone and polyethersulfone describe a family of thermoplastic polymers that contain the repeat unit aryl-SO₂-aryl, the defining feature of which is the sulfone group. Polysulfones were introduced in 1965 by Union Carbide. A typical polysulfone is produced by the reaction of a diphenol and bis(4-chlorophenyl)sulfone, forming a polyether by elimination of sodium chloride. The diphenol is typically bisphenol-A or 1,4-dihydroxybenzene. Polysulfones are commercially available from Solvay Specialty Polymers, BASF, and PolyOne Corporation.

The functions of a binder in an electrode of lithium ion battery can involve adhesion to the current collector and cohesion between active materials, which are known to be dependent on molecular weight of the binder. The higher the molecular weight of the binder the stronger the adhesion and the cohesion. Since trends in lithium ion battery moves toward slimmer and more flexible structures, the role of the binder to accommodate functional needs becomes even more demanding. The compositions described herein provide improved adhesion over previous binder materials.

It may be desirable to use multifunctional additives with an ethylene copolymer to build up its molecular weight, which can be readily achieved in existing lithium ion battery drying and annealing processes. Examples of multifunctional additives can include trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, pyromellitic anhydride, benzophenone tetracarboxylic anhydride, ethylene glycol bistrimellitate, glycerol tristrimellitate, alkylstyrene-maleic anhydride copolymer, polyazelaic polyanhydride, polyetheramines such as JEFFAMINE®, 1,2,4-benzenetricarboxylic anhydride, bisphenol A, bisphenol A esters, bisphenol A diglycidyl ethers, trimethylolpropane tris[poly(propylene glycol), amine terminated]ether, polyamide made from fatty dimer acid such as VERSAMID®, polyamines, triethylenediamine, 2,4,6-tris(dimethylaminomethyl)phenol, liquid polymercaptan, and polysulfide resin, various kinds of carbodiimides including their derivatives, and various isocyanides including their derivatives. Preferred additives include diamine, diepoxide, dianhydride, carbodiimide, isocyanide, polyamine, polyepoxide or polyanhydride types.

When the ethylene copolymer contains acid cure sites, it can be crosslinked by forming covalent bonds. Crosslinking involves curing the compounded composition, often at elevated temperature, for sufficient time to crosslink the copolymer. The term “vulcanization” is sometimes used to describe this process but vulcanization suggests that heat is required, so “crosslinking” is used herein. For acid-containing copolymers disclosed herein the crosslinking process can be conducted over a broad temperature range of about 0 to about 160° C. Ambient temperatures of 20 to 25° C. can be used, but optionally heat may be applied to facilitate curing.

For example, a blend of the un-crosslinked ethylene copolymer and a curing agent, halogenated polymer, optionally including fillers, other additives and/or other polymers can be subject to a curing step at sufficient time and temperature, such as at about 90 to about 160° C. and for a time of about 3 to about 10 hours or longer, to achieve covalent chemical bonding (i.e., crosslinking). Additional curing and annealing can be done during a lithium ion battery's typical annealing process. For example, a crosslinked ethylene copolymer may start to be formed and cured using known procedures at about 90° C. to about 140° C. for about 60 minutes. Post-cure/annealing heating may be conducted at about 90° C. to about 120° C. for several hours. Fillers and additives may include metal oxides, mixed metal oxides, metal phosphates, metal salts, or combinations of two or more thereof, and optionally electrical conductivity aids as described below.

Useful curing or crosslinking agents include diamines or multifunctional amines. The amine function can include at least one primary amine, secondary amine, tertiary amine, polyamine, or combinations of two or more thereof. An example of a small diamine that may be used is hexamethylene diamine. Amino compounds that aggregate in situ thereby providing polyamine functionality can be used. Oligomeric polyamines and other organic molecules containing more than one amine group can also be used. An oligomeric polyamine can have a high molecular weight and may include about 2 to about 100 amine groups. In applications where extraction or other loss of a small diamine could occur, the high molecular weight polyamine remains to crosslink the acidic copolymer.

The binder compositions may contain from 1 to 80 weight % of ethylene copolymer, preferably from 5 to 80 weight %, more preferably from 15 to 80 weight % of the combination of (a) and (b). Notable compositions include those with 25 to 75 or 45 to 55 weight % of ethylene copolymer, based on the combination of (a) and (b).

To produce a binder for LIB cathodes, an ethylene copolymer or a crosslinked ethylene copolymer can be combined with a single solvent or at least two component solvents, one of which would be relatively nonpolar and the other would be relatively polar in order to form a stable solution and/or concentrate. As an example but not limitation, nonpolar solvents for this application may have fairly low dielectric constant to break down crystallinity caused by polyethylenic structure. Examples of suitable nonpolar solvents are diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane and decaline. Relatively polar solvents may be used to accommodate relatively more polar polymeric materials. Useful polar solvents include acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N,N-dimethyl acetamide, N,N-diethyl acetamide. Notable solvents include ethyl acetate, tetrahydronaphthalene and N-methyl-2-pyrrolidone.

A typical method to make binder solutions or concentrates is to place a pellet, granular or powder form of the ethylene copolymer resin in a single solvent or a mixed solvent of nonpolar and polar solvents as described above. When a mixture is used, the ratio of nonpolar solvent to polar one may be from 40:60 to 90:10, preferably from 40:60 to 80:20. The amount of polymer in the solution can be from 0.01 weight % to 40 weight %, typically from 5 weight % to 15 weight %. Mechanical stirring or homogenizing is recommended to fully disperse the binder at room temperature or typically under elevated temperatures of about 40 to about 100° C. Heating of the binder solution higher than 100° C. is discouraged due to thermal sensitivity of some functional groups on ethylene copolymer.

Solutions of engineering polymers such as PEI, PAI, PC, PEEK, PS or PES in organic solvents can be prepared similarly.

The ethylene copolymer and a polymeric material selected from the group of engineering polymers such as PEI, PAI, PC, PEEK, PS or PES can generally be combined, dissolved, or dispersed by any means known to one skilled in the art, in one or more of the solvents illustrated above to produce a slurry composition. Solutions of the ethylene copolymer and solutions of engineering polymers prepared separately can be combined. In some cases, a solution of the ethylene copolymer and the engineering polymer can be prepared by mixing the polymers in the solvent or solvent blend together.

For example, a method for preparing the blend composition may comprise
(1) preparing a mixture of an ethylene copolymer comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer in an organic solvent;
(2) preparing a mixture of PEI, PAI, PC, PEEK, PS or PES in an organic solvent;
(3) combining the mixture of the ethylene copolymer and solvent with the mixture of PEI, PAI, PC, PEEK, PS or PES and solvent.

If necessary, the resin or resin mixture solution may be converted into an aqueous dispersion by techniques known to related arts by adding the organic solutions into surfactant-containing aqueous media with proper means of mixing. After formation of the aqueous dispersion, the solvent used in dissolving the resins can be removed by distillation or filtered through a micromembrane. However, sometimes the solvent can be retained. The amount of solvent can be adjusted such that the resulting slurry composition has a viscosity suitable for binding the binder composite to a cathode active material, or an electroconductivity supplying agent, used for the cathode. Examples of other binders include an ethylene (meth)acrylic acid copolymer, a lithium neutralized ethylene (meth)acrylic acid copolymer, a cellulose polymer, a polyacrylonitrile or polymethacrylonitrile. The preferred weight percent of hybrid mixture of the ethylene copolymer and engineering polymer in the solution/dispersion can be from 0.01 weight % to 40 weight %, typically from 1 weight % to 25 weight %.

Alternatively, the binder blends can be prepared by conventional coextrusion of each component resin that may or may not include partial reactions during the mixing.

The method for preparing a battery binder composition may further comprise mixing the blend composition with a metal oxide, mixed metal oxide, metal phosphate, metal salt, or combinations of two or more thereof, and optionally an electrical conductivity aid.

An electrode can comprise a metal oxide, mixed metal oxide, metal phosphate, metal salt, or combinations of two or more thereof and a binder composition wherein the binder composition can be as described above. The blend composition may further comprise a metal oxide, mixed metal oxide, metal phosphate, metal salt, or combinations of two or more thereof, and optionally an electrical conductivity aid.

The cathode active material in the slurry composition can be any one known to one skilled in the art. Suitable cathode materials for a lithium ion battery include without limitation lithiated transition metal oxides such as LiCoO₂, LiNiO₂, LiMn₂O₄, or LiV₃O₈; oxides of layered structure such as LiNiₓMn_{y}Co_{z}O₂ where x+y+z is about 1, LiCo_{0.2}Ni_{0.20}O₂, Li_{1+z}Ni_{1-x-y}CoₓAl_{y}O₂ where 0<x<0.3, 0<y<0.1, 0<z<0.06; high voltage spinels such as LiNi_{0.5}Mn_{1.5}O₄ and those in which the Ni or Mn are partially substituted with other elements such as Fe, Ga, or Cr; lithiated transition metal phosphates such as LiFePO₄, LiMnPO₄, LiCoPO₄, LiVPO₄F; mixed metal oxides of cobalt, manganese, and nickel such as those described in U.S. Pat. Nos. 6,964,828 and 7,078,128; nanocomposite cathode compositions such as those described in U.S. Pat. No. 6,680,145; lithium-rich layered composite cathodes such as those described in U.S. Pat. No. 7,468,223; and cathodes such as those described in U.S. Pat. No. 7,718,319 and the references therein. Other non-lithium metal compounds can include transition metal sulfides such as TiS₂, TiS₃, MoS₃ and transition metal oxides such as MnO₂, Cu₂V₂O₃, amorphous V₂OP₂O₅, MoO₃, V₂O₅, and V₆O₁₃.

The anode active material in the slurry composition can be any one known to one skilled in the art. Anode active materials can include without limitation carbon materials such as carbon, activated carbon, graphite, natural graphite, mesophase carbon microbeads; lithium alloys and materials which alloy with lithium such as lithium-aluminum alloys, lithium-lead alloys, lithium-silicon alloy, lithium-tin alloy, lithium-antimony alloy and the like; carbon materials such as graphite and mesocarbon microbeads (MCMB); metal oxides such as SnO₂, SnO and TiO₂; and lithium titanates such as Li₄Ti₅O₁₂ and LiTi₂O₄. In one embodiment, the anode active material is lithium titanate or graphite.

Electrical conductivity aids may be also added to the slurry to reduce the resistance and increase the capacity of the resulting electrode. Suitable conductivity aids include without limitation acetylene black, furnace black, carbon fibers and nanotubes.

A cathode active material or the anode active material can be combined with the slurry by any means known to one skilled in the art. The cathode active material or anode active material can be present in the binder composite from 0.1 to 80, 0.5 to 70, or 1 to 60 weight % of the total final composition.

The slurry composition comprising the ethylene copolymer and engineering polymer or the electrode composition comprising the slurry composition and the cathode active material (or anode active material) can be mixed by any means known to one skilled in the art such as, for example, using a ball mill, sand mill, an ultrasonic disperser, a homogenizer, or a planetary mixer.

The composition is useful as a binder composition for use in electrochemical cells such as lithium ion batteries. Accordingly, the invention also provides an electrochemical cell comprising the composition. The electrochemical cell may also comprise a negative electrode (anode), a positive electrode (cathode), an electrolyte and a separator. Other components of a battery may include a current collector.

An electrochemical cell, battery or lithium ion battery can be produced by any means known to one skilled in the art. Materials for the anode and cathode may include the compositions described above.

Any current collector known to one skilled in the art can be used. For example, metals such as iron, copper, aluminum, nickel, and stainless steel can be used. A slurry composition containing the cathode active material or the anode active material disclosed above can be applied or combined onto a current collector followed by drying the slurry and bonding the resultant electrode layer comprising the binder cathode active material or anode active material. Drying can be carried out by any means known to one skilled in the art such as drying with warm or hot air, vacuum drying, infrared drying, or dried with electron beams. The final dry binder layer can be in the range of about 0.0001 to about 6 mm, 0.001 to 5 mm, or 0.005 to 2 mm. Applying a slurry onto a current collector can be carried out by any means known to one skilled in the art such as, for example, using doctor blade, dipping, reverse roll, direct roll, gravure, or brush-painting.

An electrolyte may be in a gel or liquid form if the electrolyte is an electrolyte that can be used in a lithium ion battery. A representative electrolyte is a mixture of ethyl methyl carbonate and ethylene carbonate, typically comprising a lithium salt dissolved in the solvent. Known salts include LiClO₄, LiBF₄, LiPF₆, LiCF₃CO₂, LiB(C₂O₄)₂, LiN(SO₂CF₃)₂ LiAsF₆, or LiSbF₆.

### EXAMPLES

### Materials

NMC: Lithium Nickel Manganese Cobalt Oxide having a nominal formula of LiNi0.333Mn0.333Cu0.3330₂, commercially available under the code NM-1101 from Toda America, Battle Creek, Mich., Lot 7711206.

Carbon black: Super C65, commercially available from Timcal, Westlake, Ohio, Batch 555.

PEI: a polyetherimide, commercially available under the trade name Ultem® 1000 (1.27 g/cm³, T_{g}=217° C.), commercially available from Sabic Americas, Inc., Houston, Tex., used as 10 weight % solution in NMP.

ECP-1: an ethylene copolymer containing 63 weight % methyl acrylate and 4.7 weight % of ethyl hydrogen maleate, the remainder ethylene, used as 10 weight % solution in NMP.

Al foil is 1 mil aluminum foil from Allfoils.

NMP: N-Methyl-2-pyrrolidone commercial grade.

IPA: isopropyl alcohol commercial grade.

DCM: dichloromethane commercial grade.

Electrolyte: Novolyte 1M LiPF₆ 70-30 EMC-EC.

In the following examples, PEI alone and PEI blended with ECP-1 were used to prepare cathode binder compositions. Coin cell electric cells were prepared and the performance tested.

### General Procedure for Cathode Paste Formulation

All parts disclosed here are by weight. Carbon black, a first portion of solvent, and binder solution were combined in a vial and mixed using a planetary centrifugal mixer (ARE-250, Thinky USA, Inc., Laguna Hills, Calif.) at 2000 rpm for 2 minutes. NMC and additional amount of solvents were added and the slurry again centrifugally mixed at 1000 rpm for 2 minutes. The mixture was further homogenized twice using a rotor-stator (model PT 10-35 GT, 7.5 mm dia. stator, Kinematicia, Bohemia, N.Y.) for 1 minute at 6000 rpm and then for 5 minutes at 9500 rpm. During homogenization, the temperature of the vial was kept below 60° C., cooling with an ice bath if needed. The vial was secured in a clamp and manually moved about the disperser shaft for the duration of the homogenization. Finally the slurry was centrifugally mixed again at 1000 rpm for two minutes. The cathode paste compositions are summarized in Table 1.

TABLE 1

| | Example | | | |
|---|---|---|---|---|
| | A | | B | |
| | Weight (g) | Solid (g) | Weight (g) | Solid (g) |
| Carbon black | 0.106 | 0.106 | 0.1064 | 0.1064 |
| NMC | 2.031 | 2.031 | 1.935 | 1.935 |
| NMP | 3.021 | | 3.092 | |
| PEI/NMP (10%) | 1.061 | 0.106 | 0.515 | 0.0515 |
| ECP-1/NMP (10%) | 0 | 0 | 0.543 | 0.0543 |
| Total | 6.219 | 2.243 | 7.149 | 2.147 |

### General Procedure for Cathode Paste Casting, Calendaring and Preparation of Coin Cells

Using a doctor coater, each test slurry was uniformly applied on the surface of lithium ion battery grade Al foil (1 mil=25.4 micron thickness) that was pre-cleaned by isopropyl alcohol and dichloromethane and gently scratched to facilitate adhesion. The slurry (i.e., dispersion of cathode active material, carbon black, and binder in a solvent) coated cathode was dried in a convection oven (model FDL-115, Binder Inc., Great River, N.Y.) for an hour under ramping temperature from 30° C. to 100° C. The resulting 51-mm wide cathode was placed between 125-μm thick brass sheets and passed through a calendar three times using 100 mm diameter steel rolls at ambient temperature with nip forces increasing in each of the passes, starting at 154 kg with the final pass at 257 kg. The thicknesses of the cathodes are summarized in Table 2.

TABLE 2

| Paste | | Thickness (mil) | | | | | |
|---|---|---|---|---|---|---|---|
| Composition | Component | 1 | 2 | 3 | 4 | 5 | Mean |
| A | Foil | 1.05 | 1 | 1.05 | 1 | 1.05 | 1.03 |
| | Cathode | 2.95 | 3.4 | 3.45 | 4.3 | 3.5 | 3.52 |
| | Pressed | 2.4 | 3.25 | 3.4 | 3.9 | 3.15 | 3.22 |
| B | Foil | 1.05 | 1.05 | 1 | 1 | 1 | 1.02 |
| | Cathode | 2.2 | 2.85 | 3.75 | 3.35 | 2.7 | 2.97 |
| | Pressed | 2.15 | 2.7 | 3.4 | 3.15 | 2.65 | 2.81 |

Cathode disks were punched out by using a 0.5-inch diameter arch punch, and were further dried overnight in a dry-box antechamber under vacuum at 90° C. After 18 hours, inside an Ar (argon) dry box, non-aqueous electrolyte lithium-ion CR2032 coin cells were prepared for electrochemical evaluation. The coin cell parts (case, spacer, wave spring, gasket, and lid) and coin cell crimper were obtained from Hohsen Corp (Osaka, Japan). The anodes were lithium metal (275 μm thick, Chemetall Foote, Kings Mountain, N.C.) and the separator was a microporous polyolefin (CG2325, Celgard, LLC. Charlotte, N.C.). The electrolyte was ethyl methyl carbonate (70 v %)/ethylene carbonate (30 v %)/1 M LiPF₆ (Novolyte Purolyte® A2 Series, BASF, Independence, Ohio).

Two cells for each cathode paste composition were prepared. The cells are summarized in Table 3. C-rate is reciprocal of the time needed to completely discharge or charge a battery, which is typically expressed as the relative discharge current expressed as a multiple of the numeric value of the discharge capacity measured at the lowest discharge rate of 14 mA/g. Thus if the cell capacity at the lowest discharge rate was 2.8 mAh, 0.1 C was a discharge rate of 0.28 mA and 1 C was a discharge rate of 2.8 mA.

TABLE 3

| | | Weight of cathode | |
|---|---|---|---|
| Paste Composition | Coin cell | active material | C-rate |
| A | A1 | 0.0226 | 0.00174 |
| | A2 | 0.0216 | 0.00161 |
| B | B1 | 0.0222 | 0.00169 |
| | B2 | 0.0230 | 0.00179 |

Table 3 show four different coin cells based on two different binder systems: a polyetherimide and a blend of polyetherimide and ethylene copolymer elastomer. The cells were prepared using cathode active material of NMC (Lithium Nickel Manganese Cobalt Oxide (LiNi_{0.333}Mn_{0.333}Co_{0.333}O₂) and carbon black (Super C65, Timcal, Westlake, Ohio) by above described methods. The cells of A1, A2, B1 and B2 were cycled using a commercial battery tester (Series 4000, Maccor, Tulsa, Okla.) at ambient temperature using constant current charging and discharging between voltage limits of 3.0 to 4.25 V at a current of 35 mA per gram of cathode active material (at about 0.25 C-rate). The results of testing are summarized in Table 4 (discharge capacity) and Table 5 (coulombic efficiency). Also shown is a similar cell designated “V” prepared using ECP-1 as a binder. They provided capacity of about 135 mAh/g under 4.25 V charge, 3 V discharge and 0.25 C-rate. Although their discharge capacity is smaller than NMC's theoretical value of 160 mAh/g possibly due to its 0.25 C-rate, they all performed well by showing stable charge-discharge cycles up to 50 in their half cells, even without optimization.

TABLE 4
Discharge Capacity (mAh/g)

| | | | | PEI/ECP-1 | | |
|---|---|---|---|---|---|---|
| | | PEI | | Blend | | |
| | | Composition | | Composition | | ECP-1 |
| | Coin cell | A1 | A2 | B1 | B2 | V |
| Cycle | 1 | 111.9 | 125.5 | 126.7 | 117.9 | 119.4 |
| | 5 | 115.6 | 126.7 | 135.6 | 123.5 | 128.0 |
| | 10 | 116.3 | 128.9 | 137.2 | 125.6 | 128.7 |
| | 15 | 117.4 | 128.5 | 138.1 | 124.7 | 127.8 |
| | 20 | 117.8 | 129.5 | 137.0 | 126.0 | 126.9 |
| | 25 | 118.9 | 129.0 | 137.2 | 124.5 | 126.0 |
| | 30 | 118.5 | 130.2 | 138.0 | 125.5 | 124.5 |
| | 35 | 119.7 | 129.8 | 136.9 | 124.2 | 123.5 |
| | 40 | 118.4 | 130.3 | 136.8 | 124.8 | 118.7 |
| | 45 | 118.2 | 131.9 | 137.1 | 123.8 | 113.0 |
| | 50 | 118.2 | 129.1 | 134.7 | 122.8 | 95.2 |

TABLE 5
Coulombic Efficiency (%)

| | | | PEI/ECP-1 | | |
|---|---|---|---|---|---|
| | PEI | | Blend | | |
| Coin cell | Composition | | Composition | | |
| Cycle | A1 | A2 | B1 | B2 | ECP-1 |
| 1 | 77.78 | 78.27 | 77.68 | 77.83 | 79.75 |
| 5 | 97.99 | 98.23 | 98.29 | 98.18 | 98.75 |
| 10 | 97.84 | 99.14 | 97.2 | 99.07 | 97.89 |
| 15 | 98.28 | 98.17 | 98.54 | 97.96 | 98.13 |
| 20 | 97.47 | 97.51 | 97.27 | 98.74 | 98.07 |
| 25 | 97.78 | 97.81 | 96.75 | 97.18 | 98.05 |
| 30 | 97.25 | 97.27 | 98.05 | 98.1 | 97.9 |
| 35 | 97.91 | 98.62 | 97.22 | 96.94 | 98.39 |
| 40 | 96.93 | 97.58 | 96.32 | 97.07 | 97.73 |
| 45 | 97 | 98.61 | 97.49 | 97.08 | 98.34 |
| 50 | 95.75 | 97.42 | 96.67 | 96.18 | 96.4 |

### Voltage Holding Test at 4.3 V (Li+)

Another coin cell was assembled from a blend of PEI and ECP-1 using procedures described above. The half-cell was exposed to continuous voltage of 4.3 V for 200 hours to see if any cell damage occurred. The cell had 92.3% capacity retention over the test period, indicating very good performance.

1. A blend composition comprising
(a) an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof wherein the polymer contains copolymerized units of 2 to 80 weight % of the comonomer; and
(b) a polymeric material selected from the group consisting of polyetherimide, polyamideimide, polycarbonate, polyetheretherketone, polysulfone and polyethersulfone.

2. The composition of claim 1 comprising 1 to 80 weight % of the ethylene copolymer, based on the combination of (a) and (b).

3. The composition of claim 2 comprising 15 to 80 weight % of the ethylene copolymer, based on the combination of (a) and (b)

4. The composition of claim 1 wherein the comonomer comprises a derivative of an α,β-unsaturated monocarboxylic acid.

5. The composition of claim 4 wherein the comonomer is an alkyl methacrylate, an alky acrylate, or combinations thereof.

6. The composition of claim 1 wherein the ethylene copolymer is an ethylene methyl acrylate dipolymer, ethylene ethyl acrylate dipolymer, ethylene butyl acrylate dipolymer, ethylene methyl acrylate glycidyl methacrylate terpolymer, ethylene butyl acrylate glycidyl methacrylate terpolymer, or combinations of two or more thereof.

7. The composition of claim 1 wherein the ethylene copolymer is an elastomer derived from copolymerization of
(a) from 13 to 50 weight % of ethylene;
(b) from 50 to 80 weight % of an alkyl acrylate; and
(c) from 0 to 7 weight % of a monoalkyl ester of 1,4-butene-dioic acid, wherein all weight percentages are based on total weight of components (a) through (c) in the copolymer.

8. The composition of claim 1, wherein (b) comprises a polyetherimide.

9. The composition of claim 1 further comprising a curing agent.

10. The composition of claim 9 wherein the curing agent comprises trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, pyromellitic anhydride, benzophenone tetracarboxylic anhydride, ethylene glycol bistrimellitate, glycerol tristrimellitate, alkylstyrene-maleic anhydride copolymer, chlorendic anhydride, polyazelaic polyanhydride, polyether amines, 1,2,4-benzenetricarboxylic anhydride, bisphenol A, bisphenol A esters, bisphenol A diglycidyl ether, trimethylolpropane tris[poly(propylene glycol), amine terminated]ether, polyamide made from fatty dimer acid, polyamine, triethylenediamine, 2,4,6-tris(dimethylaminomethyl)phenol, liquid polymercaptan, polysulfide resin, a carbodiimide or a derivative thereof, an isocyanide or a derivative thereof, or combinations of two or more thereof.

11. The composition of claim 9 wherein the curing agent comprises a diamine or polyamine.

12. The composition of claim 1 wherein the ethylene copolymer is crosslinked.

13. The blend composition of claim 1 further comprising a metal oxide, mixed metal oxide, metal phosphate, metal salt, or combinations of two or more thereof, and optionally an electrical conductivity aid.

14. A method for preparing the blend composition of claim 1 comprising
(1) preparing a mixture comprising an ethylene copolymer or combination thereof comprising copolymerized units of ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; wherein the polymer contains copolymerized units of 2 to 80 weight % of the comonomer and an organic solvent;
(2) preparing a mixture comprising a polymeric material selected from the group consisting of polyetherimide, polyamideimide, polycarbonate, polyetheretherketone, polysulfone and polyethersulfone, and an organic solvent;
(3) combining the mixture of the ethylene copolymer and the mixture of the polymeric material.

15. The method of claim 12 wherein the polymeric material comprises a polyetherimide.

16. The method of claim 14 wherein the solvents comprise diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane, decaline, acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N,N-dimethyl acetamide, N,N-diethyl acetamide or combinations thereof.

17. The method of claim 16 wherein the solvents comprise ethyl acetate or N-methyl-2-pyrrolidone.

18. The method of claim 14 further comprising mixing the blend composition with a metal oxide, mixed metal oxide, metal phosphate, metal salt, or combinations of two or more thereof, and optionally an electrical conductivity aid.

19. An electrochemical cell comprising the composition of claim 1.

20. The electrochemical cell of claim 19 comprising a negative electrode (anode), a positive electrode (cathode), an electrolyte and a separator.

21. The electrochemical cell of claim 20 wherein the positive electrode comprises a binder composition and a cathode active material wherein the binder composition is as characterized in claim 1; and the cathode active material comprises a lithiated transition metal oxide or lithiated transition metal phosphate, or combinations thereof.

22. The electrochemical cell of claim 20 wherein the negative electrode comprises a binder composition and an anode active material wherein the binder composition is as characterized in claim 1; and the anode active material comprises carbon, lithium titanate, Si, Sn, Sb, or alloys or precursors to lithium alloys with Si, Sn, or Sb.

23. A lithium ion battery electrode comprising a binder composition and a cathode active material wherein the binder composition is as characterized in claim 1; and the cathode active material comprises a lithiated transition metal oxide or lithiated transition metal phosphate, or combinations thereof.

24. A lithium ion battery electrode comprising a binder composition and an anode active material wherein the binder composition is as characterized in claim 1; and the anode active material comprises carbon, lithium titanate, Si, Sn, Sb, or alloys or precursors to lithium alloys with Si, Sn, or Sb.
